(19) United States
(12) Patent Application Publication
(10) Pub. No.: US 2002/0054131 A1
(43) Pub. Date: May 9, 2002

(54) Reproducing apparatus and reproducing method

(76) Inventors: Masao Ozawa, Ibaraki (JP); Yoshitaka Ukita, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/939,774

(22) Filed: Aug. 28, 2001

(30) Foreign Application Priority Data
Sep. 1, 2000 (JP) P2000-265773
Jul. 25, 2001 (JP) P2001-224947

(51) Int. Cl. G09G 5/00

(52) U.S. Cl. 345/784

(57) ABSTRACT

If the same instructions are continuously inputted over a predetermined number of times when a plurality of instructions on picture display are entered by a user and accumulated while display data recorded on a recording medium is read out, processed and displayed, the same continuous instruction is converted into other instructions.

### BACKGROUND OF THE INVENTION

1. Field of the Invention

The present invention relates to a reproducing apparatus and a reproducing method in which data recorded on a recording medium is processed and displayed on a screen based upon user's instruction.

2. Description of the Related Art

Electronic dictionaries in which dictionary data are read out from a dictionary memory by entering commands from a keyboard and the dictionary data thus read out are displayed on a display section have been spreading increasingly. In such electronic dictionaries, one line is fed or one line is returned by one click of a line feed key or a line return key.

However, in the above conventional electronic dictionary, when dictionary data of consecutive lines in a non-expanding area are scrolled and displayed in order to temporarily expand and display dictionary data compressed and recorded on a dictionary memory on a display section, a time for expanding compressed dictionary data is required so that scroll is delayed. As a result, scroll of a scroll key entered during scrolling is executed after plenty of time had elapsed since a user entered keystroke data, causing a user to feel a sense of incongruity in the scroll and display. There is then a disadvantage that a quality of scroll and display is degraded.

In particular, there is known an operation means called a jog dial by which a user can feed lines or return lines by rotating the jog dial in the positive direction or by rotating the jog dial In the opposite direction and a user can enter a decision by pressing the jog dial in the radius direction. When such jog dial is in use, there is then a disadvantage that a user is caused to feel a stronger sense of incongruity when a user scrolls character data since a lot of keystroke data can be entered in a short period of time.

### SUMMARY OF THE INVENTION

In view of the aforesaid aspect, it is an object of the present invention to provide a reproducing apparatus and a reproducing method in which users can be prevented from feeling a sense of incongruity when character data are scrolled and displayed.

According to an aspect of the present invention, there is provided a reproducing apparatus for reading out compressed display data comprising a plurality of coupled page data from a recording medium and displaying the display data based upon operations by a user. This reproducing apparatus is comprised of a reproducing device for reproducing and reading out the compressed display data from the recording medium as reproducing data, a data restoring device for expanding the compressed reproducing data to restore original display data, a memory for storing therein the display data restored by the data restoring device, a display device for displaying a predetermined portion of the display data stored in the memory as display data, an operation device for entering instruction information to instruct the direction in which display data displayed on the display device is scrolled, a hold device for holding instruction information entered by the operation device each time the operation device is operated and a control device for scrolling display data displayed on the display device at the unit of page data when instruction information held on the hold device instructs scroll in which display data is continuously scrolled in the same direction over a predetermined number of times.

According to other aspect of the present invention, there is provided a reproducing apparatus for reading out display data comprising a plurality of coupled page data from a recording medium and displaying the display data on a display screen based upon operations by a user. This reproducing apparatus is comprised of a reproducing device for reproducing and reading out the display data from the recording medium as reproducing data, a display data processing device for processing the reproduced reproducing data such that the reproduced reproducing data matches the display screen and outputting the processed reproducing data as display data, a control device for displaying part of the display data on the display screen as display data, an operation device for entering instruction information to instruct the direction in which the control device scrolls displayed pictures and an instruction information hold device for holding instruction information entered by the operation device, wherein the control device scrolls display data displayed on the display screen at the unit of page data when instruction information held on the hold device instructs scroll in which display data is continuously scrolled in the same direction over a predetermined number of times.

In accordance with a further aspect of the present invention, there is provided a reproducing method of reading out display data from a recording medium in which the display data comprising a plurality of coupled page data are stored and displaying a picture on a display screen based upon user's operations held in a hold device in which user's instruction is held each time a user operates a reproducing apparatus. This reproducing method is comprised of the steps of a step of reproducing and reading out the display data from the recording medium, a step of converting the read out display data into data of a data format that can be displayed on a display screen, a step of displaying the converted display data of data format, which can be displayed on the display screen, on the display screen, a step of converting continuous instructions over a predetermined number from the same user into other operation instructions when user's instructions held in the hold device are the same continuous instructions over a predetermined number, and a step of displaying display data based upon the other instructions when user's instructions are converted into the other instructions.

### BRIEF DESCRIPTION OF THE DRAWINGS

FIG. 1 is a block diagram showing an arrangement of an electronic dictionary to which an embodiment of the present invention is applied;

FIG. 2 is a diagram showing relationships between stored data and displayed data;

FIG. 3 is a diagram showing data structures;

FIG. 4 is a flowchart to which reference will be made in explaining processing executed when data are accumulated in a key buffer;

FIG. 5 is a flowchart to which reference will be made in explaining processing executed when keystroke data of the same kind are read out from the key buffer;

FIG. 6 is a flowchart to which reference will be made in explaining keystroke processing;

FIGS. 7A to 7C are respectively diagrams showing processing executed for keystroke data and the number of data inputted to the key buffer, wherein FIG. 7A is a diagram showing keystroke data, FIG. 7B is a diagram showing processing executed for pictures displayed on the screen and FIG. 7C is a diagram showing the number of data inputted to the key buffer;

FIGS. 8A to 8C are respectively diagrams showing processing executed for other keystroke data and the number of data inputted to the key buffer, wherein FIG. 8A is a diagram showing keystroke data, FIG. 8B is a diagram showing processing executed for pictures displayed on the screen and FIG. 8C is a diagram showing the number of data inputted to the key buffer;

FIGS. 9A to 9C are respectively diagrams showing page feed processing according to a pattern 1, wherein FIG. 9A is a diagram showing keystroke data, FIG. 9B is a diagram showing processing executed for pictures displayed on the screen and FIG. 9C is a diagram showing the number of data inputted to the key buffer;

FIGS. 10A to 10C are respectively diagrams showing scroll processing according to a pattern 2, wherein FIG. 10A is a diagram showing keystroke data, FIG. 10B is a diagram showing processing executed for pictures displayed on the screen and FIG. 10C is a diagram showing the number of data inputted to the key buffer;

FIGS. 11A to 11C are respectively diagrams showing scroll processing according to a pattern 3, wherein FIG. 11A is a diagram showing keystroke data, FIG. 11B is a diagram showing processing executed for pictures displayed on the screen and FIG. 11C is a diagram showing the number of data inputted to the key buffer;

FIG. 12A is a top view showing an outward appearance of an electronic dictionary;

FIG. 12B is a left-hand side elevational view showing an outward appearance of an electronic dictionary;

FIG. 12C is a front view showing an outward appearance of an electronic dictionary;

FIG. 12D is a right-hand side elevational view showing an outward appearance of an electronic dictionary;

FIG. 12E is a rear view showing an outward appearance of an electronic dictionary; and

FIG. 13 is a flowchart to which reference will be made in explaining dictionary retrieval fundamental operations for retrieving words in the forward direction.

### DESCRIPTION OF THE PREFERRED EMBODIMENT

A reproducing apparatus according to this embodiment is applied to an electronic dictionary in which line scrolls and page scrolls can be distinguished from each other and displayed based upon a predetermined number of clicks and a speed of clicking done by a jog dial which can feed or return lines when the jog dial is rotated in the positive direction or in the opposite direction and which can decide inputted data when the jog dial is pressed in the radius direction.

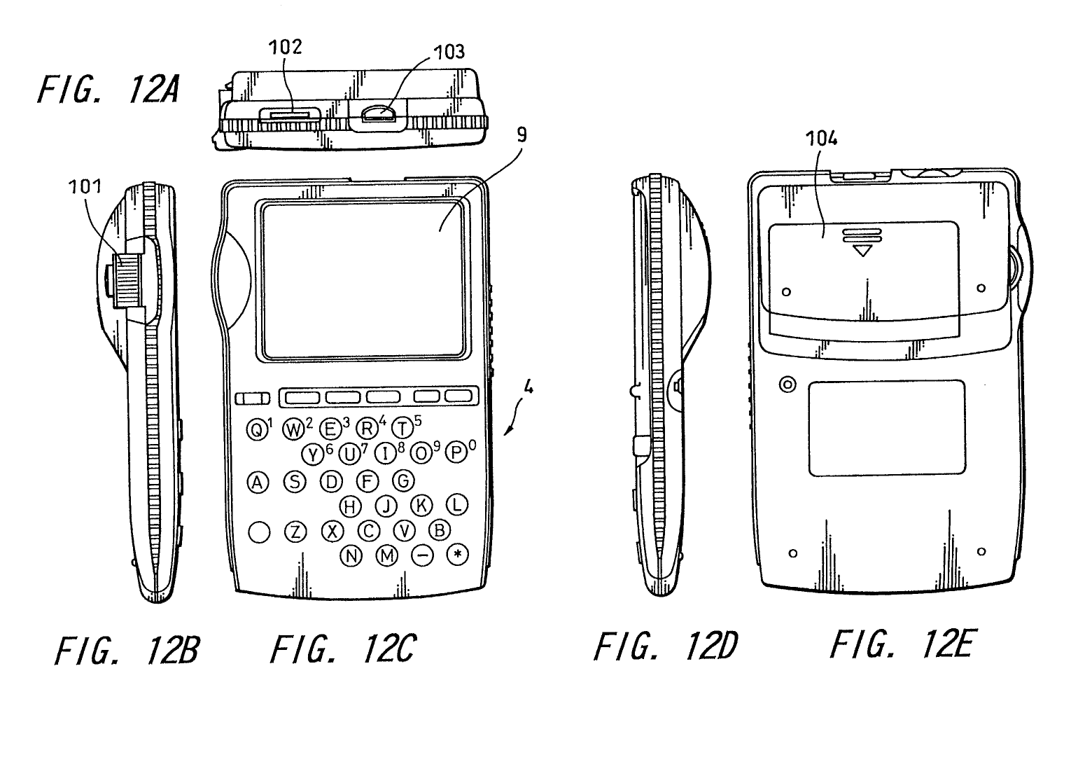

FIGS. 12A, 12B, 12C, 12D and 12E are diagrams each showing an outward appearance of an electronic dictionary according to an embodiment of the present invention, respectively. FIG. 12C is a front view of an electronic dictionary according to an embodiment of the present invention. As shown in FIG. 12C, the electronic dictionary includes a display section 9 comprised of an LCD (liquid-crystal display) disposed on its upper portion so as to become able to display dictionary data and keys 4 disposed on its lower portion so as to become able to input various data. FIG. 12B is a left-hand side elevational view of this electronic dictionary. As shown in FIG. 12B, the electronic dictionary includes a jog dial 101 which can feed lines or return lines when it is rotated in the positive direction or in the opposite direction and which can also decide keystroke data when it is pressed in the radius direction. FIG. 12A is a top view of the electronic dictionary. As shown in FIG. 12A, the electronic dictionary includes a contrast volume 102 capable of adjusting contrast of the display section 9 and a return button 103 for returning a page to a previous page. FIG. 12E is a rear view of the electronic dictionary. As shown in FIG. 12E, the electronic dictionary includes a cell lid 104 in which there is stored a cell for supplying a power supply voltage to the electronic dictionary.

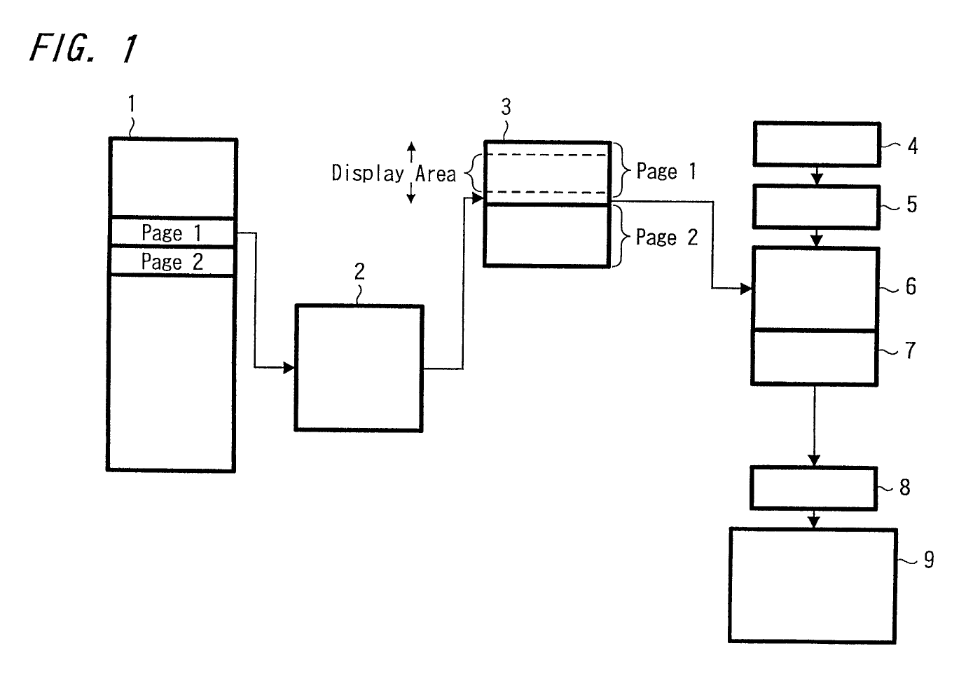

FIG. 1 is a block diagram showing an arrangement of an electronic dictionary.

As shown in FIG. 1, this electronic dictionary includes a dictionary ROM (read-only memory) 1 in which there are stored compressed dictionary data, an expanding processing block 2 for expanding compressed dictionary data read out from the dictionary ROM 1, an SRAM (static random-access memory) 3 in which there are temporarily stored expanded dictionary data, keys 4 for inputting data by user's keystrokes, a key buffer 5 for storing therein keystroke inputted data, a CPU (central processing unit) 6 which is taking charge of controls, an LCD controller 7 disposed within the CPU 6 to control display operations of an LCD 9, a driver 8 for driving the LCD 9 so as to display data and the LCD 9 of the display section.

While the LCD 9 is able to display dictionary data in which 8 lines constitute one page, considering a time required to expand compressed data, dictionary data of pages 1 and 2 larger than a display area should be expanded and stored in the SRAM 3.

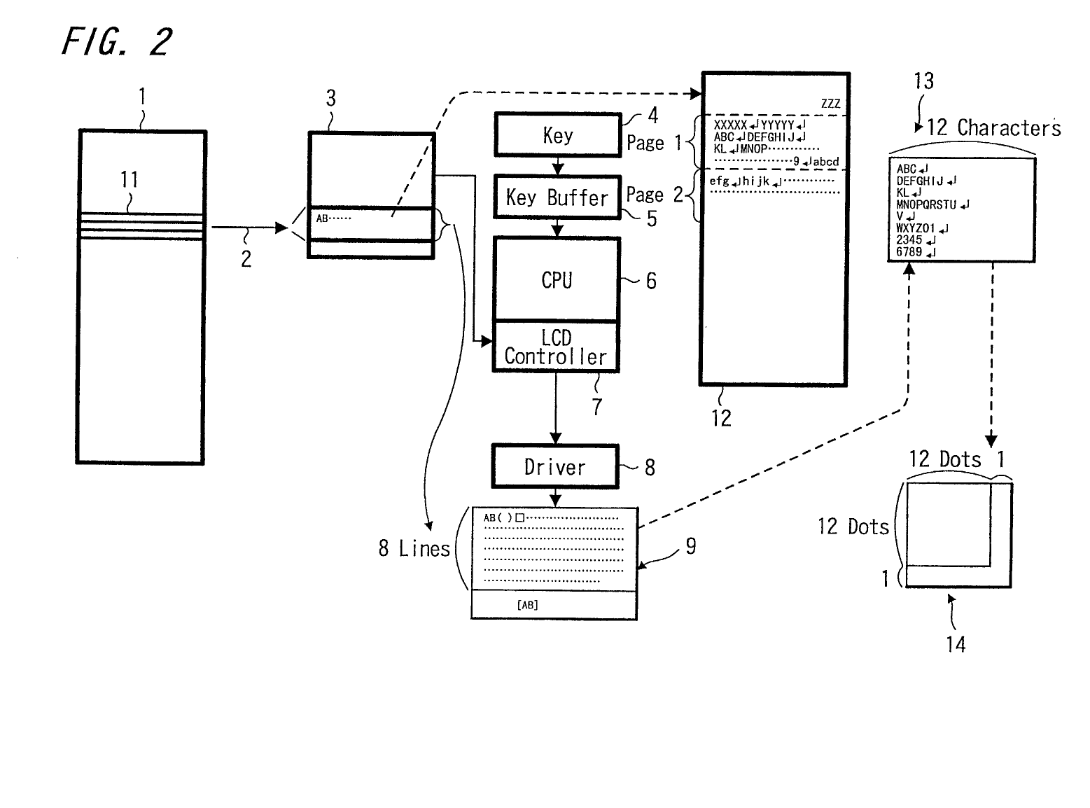

FIG. 2 is a diagram showing relationships between stored data and display data. In order to simplify a description of the present invention, instead of actual dictionary data, characters may be simplified and described. As shown in FIG. 2, compressed data 11 is stored in the dictionary ROM 1. This compressed data 11 is expanded to original data by the expanding processing block 2 and stored in the SRAM 3. Data stored in the SRAM 3 are data shown in an SRAM area 12 shown by dashed lines in FIG. 2.

On the other hand, data displayed on the LCD 9 are data shown on an LCD display screen 13 shown by dashed lines in FIG. 2. The LCD 9 includes a display area to display 8 lines, each line being comprised of 12 characters in the case of 2-byte code character such as the Japanese language. In the case of one-byte code character such as the alphabet, the LCD 9 includes a display area to display 10 lines, each line being comprised of 24 characters. As shown in FIG. 2, in the case of 2-byte code character, one character 14 is comprised of 12 dots×12 dots and each dot includes a blank. In the case of one-byte code character, one character 14 is comprised of 5 dots×7 dots and each dot includes a blank.

Data shown on the LCD display screen 13 are a first line “ABC”, a second line “DEFGHIJ”, a third line “KL”, a fourth line “MNOPQRSTU”, a fifth line “V”, a sixth line “WXYZ01” a seventh line “2345” and an eighth line “6789”.

On the other hand, data shown on the SRAM area 12 are “ZZZ”, “XXXXX”, “YYYYY”, “ABC”, “DEFGHIJ”, “KL”, “MNOPQRSTU”, “V”, “WXYZ01”, “2345”, “6789”, “abcdefghijk” and “. . . ”.

Specifically, the data shown in the SRAM 12 are stored in the front of the upward direction and in the back of the downward direction in a larger amount, e.g., about data amount of two pages as compared with the data amount of one page shown on the LCD display screen 13.

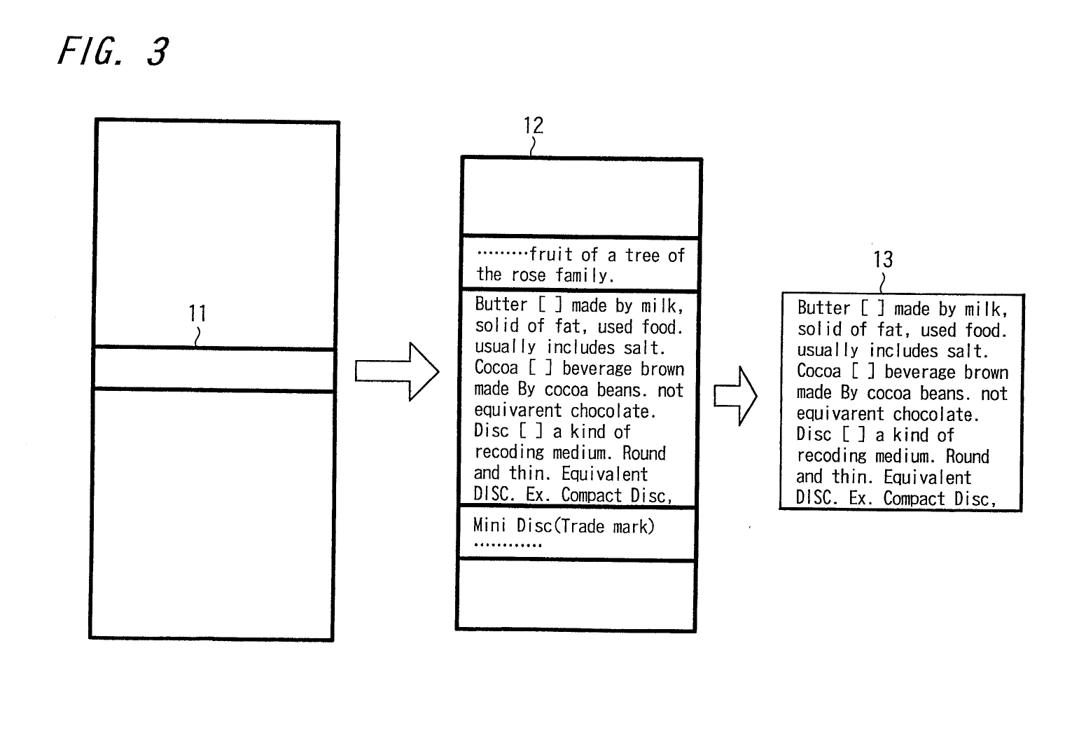

FIG. 3 is a diagram showing a data structure. This data structure will be described with reference to dictionary data in actual practice.

As shown in FIG. 3, after the compressed data 11 had been expanded, the compressed data thus expanded is stored in the SRAM area 12, and dictionary data comprised of 10 lines and 24 characters indicative of one page, which is part of the dictionary data stored in the SRAM area 12, is displayed on the LCD display screen 13.

As shown in FIG. 3, data displayed on the LCD display screen 13 are “Butter [ ] made of milk, “solid of fat, used food”, “usually includes salt”, “Cocoa [ ] beverage brown”, “made By cocoa beans. not”, “equivalent chocolate”, “Disc [ ] a kind of”, “recording medium. Round”, “and thin. Equivalent”, “DISK. Ex. Compact Disc.”

On the other hand, data displayed on the SRAM area 12 are “. . . fruit of a tree of”, “the rose family.”, “Butter [ ] made by milk,” “solid of fat, used food.”, “usually includes salt.”, “Cocoa [ ] beverage brown”, “made By cocoa beans, not”, “equivalent chocolate.”. Disc [ ] a kind of ”, “recording medium. Round”, “and thin. Equivalent”, “DISK. Ex. Compact Disc, ”. “Mini Disc (Trade mark)”, “. . . ”.

As described above, data stored in the SRAM area 12 are expanded in front and back by a data amount larger than a data amount of data displayed on the LCD display screen 13 and then stored.

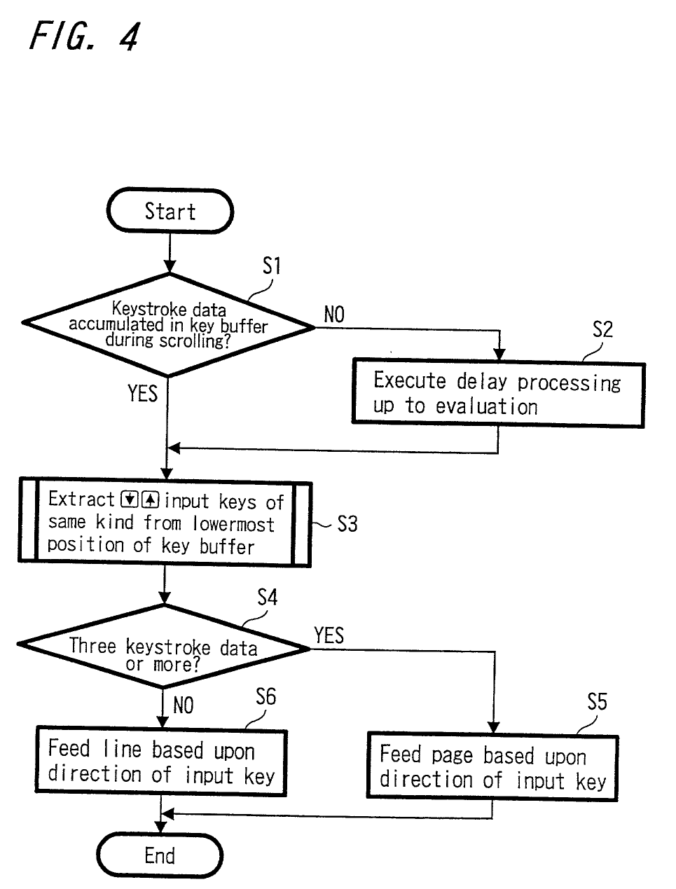

Operations of the electronic dictionary having the above arrangement will be described below with reference to FIG. 4. FIG. 4 is a flowchart to which reference will be made in explaining processing executed when data are accumulated in the key buffer 5.

Referring to FIG. 4, and following the start of operation, it is determined at a decision step S1 whether or not a time at which one keystroke data is stored in the key buffer 5 is a time during which a user is scrolling. To be concrete, it is determined by the CPU 6 whether or not the user is scrolling near a time during which keystroke data is stored in the key buffer 5 by the keystrokes of the keys 4.

If the user is not scrolling at the time at which one keystroke data is accumulated in the key buffer 5 at the decision step S1, then control goes to a step S2, whereat delay processing is executed until the keystroke data accumulated in the key buffer 5 is evaluated. To be concrete, the CPU 6 executes the delay processing to evaluate the keystroke data in the key buffer 5 after a predetermined time has elapsed since keystroke data was stored in the key buffer 5 by the keystrokes of the keys 4.

If, on the other hand, the user is not scrolling at the time at which one keystroke data is accumulated in the key buffer 5 at the decision step S1, and after the delay processing up to evaluation at the step S2 had been executed, then control goes to a step S3. At the step S3, the continuous keystroke data of the same kind are extracted from the key buffer 5. To be concrete, the CPU 6 extracts only continuous keystroke data of upward direction scroll instruction (↑) or only continuous keystroke data of downward direction scroll instruction (↓) from the key buffer 5 together.

If keystroke data is accumulated in the key buffer 5 while the user is scrolling at the decision step S1, then 12 control immediately goes to the step S3 in such a manner that the delay processing to evaluate the keystroke data accumulated in the key buffer 5 may not be executed.

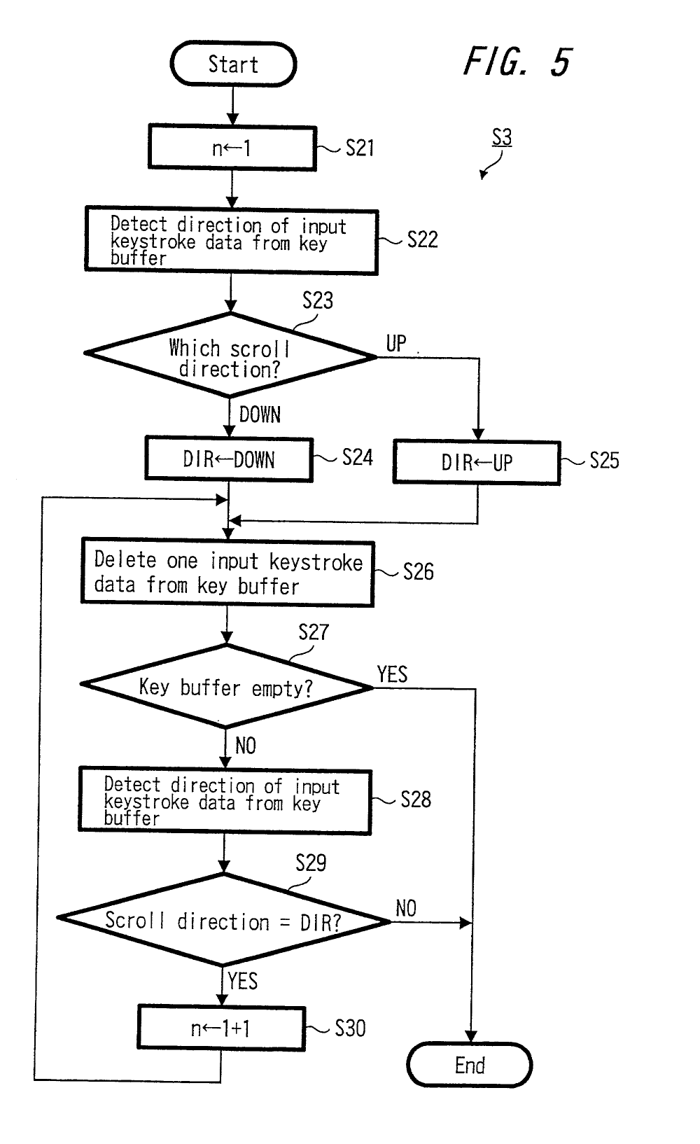

The step S3 shown in the flowchart of FIG. 4 will be described more fully with reference to a flowchart of FIG. 5.

Referring to FIG. 5, and following the start of operation, a counter for counting the number of keystroke data of the same kind is initialized at a step S21. At a step S22, the direction of keystroke data accumulated in the lowermost position of the key buffer 5, i.e., the direction of first keystroke data is read out from the key buffer 5 and detected. At the step S22, the inputted keystroke data is not taken out from the key buffer 5, i.e., the inputted keystroke data is not erased. At the next decision step S23, the direction of the keystroke data read out from the key buffer 5 is judged. If the scroll direction is the upward scroll direction at the decision step S23, then control goes to a step S25. If, on the other hand, the scroll direction is the downward scroll direction at the decision step S23, then control goes to a step S24. At the step S24, “DOWN” is set to the “DIR” indicative of the scroll direction of the first keystroke data accumulated in the key buffer 5. At the step S25, “UP” is set to the “DIR”.

After the scroll direction had been set to the “DIR” at the step S24 or S25, control goes to a step S26, whereat keystroke data whose evaluation has been finished is deleted from the key buffer 5. That is, in this case, the oldest keystroke data that had been accumulated at the lowermost position of the key buffer 5 is deleted. When three keystroke data are accumulated in the key buffer 5, the first inputted keystroke data was deleted from the key buffer 5 and the second inputted keystroke data is changed to the oldest inputted keystroke data by the operations at the step S26.

It is determined at the next decision step S27 whether keystroke data is not stored in the key buffer 5 after one keystroke data had been deleted from the key buffer 5 at the step S26.

If keystroke data is not stored in the key buffer 5 at the decision step S27, then control is ended and proceeds to the step S4 in the flowchart of FIG. 4. If keystroke data is still stored in the key buffer 5 at the decision step S27, then control goes to a step S28, whereat the scroll direction of the oldest inputted keystroke data is read out from the key buffer 5 similarly to the step S22. In the next decisions step S29, it is determined whether or not the scroll direction indicated by the keystroke data read out at the step S28 is equal to the DIR, i.e., the scroll direction indicated by the oldest keystroke data inputted to the key buffer 5. If the scroll direction of the new read out keystroke data and the scroll direction set to the DIR are equal to each other at the decision step S29, then control goes to a step S30. If, on the other hand, they are not equal to each other at the decision step S29, then control is ended and proceeds to the step S4 in the flowchart of FIG. 4. At the step S30, the count of the counter of the keystroke data of the same kind is incremented by one and control goes back to the step S26.

According to the above processing, the number of the successively inputted keystroke data of the same kind is set to a variable n and the scroll direction inputted by the keystroke data is set to the variable DIR. Further, the continuous keystroke data of the same kind are deleted from the key buffer 5.

Referring to FIG. 4, it is determined at the decision step S4 based upon the number set to the variable n at the step S3 whether or not the number of continuously inputted keystroke data of the same kind is three or more. To be concrete, it is determined by the CPU 6 whether or not there are extracted three or more keystroke data of the continuous upward direction scroll instruction (↑) or three or more keystroke data of the continuous downward direction scroll instruction (↓)from the key buffer 5.

If it is determined at the decision step S4 that there are continuously inputted three keystroke data or more, then control goes to a step S5, whereat pages are fed in the direction based upon the DIR indicative of the direction of the inputted keystroke data. To be concrete, if three keystroke data or more of the upward direction scroll instruction (↑) or three keystroke data or more of the downward direction scroll instruction (↓) are all extracted from the key buffer 5, then the CPU 6 executes scrolling to feed pages in the upward direction or to feed pages in the downward direction on the LCD 9.

If it is determined at the decision step S4 that the number of the continuously inputted keystroke data of the same kind is less than three, then control goes to a step S6, whereat lines are fed in the direction based upon the DIR indicative of the direction of the inputted keystroke data. To be concrete, if it is determined by the CPU 6 that three keystroke data or more of the upward direction scroll instruction (↑) or three keystroke data of more of the downward direction scroll instruction (↓) are not all extracted from the key buffer 5, then the CPU 6 executes scrolling to feed one to two lines in the upward direction or to feed one to two lines in the downward direction on the LCD 9.

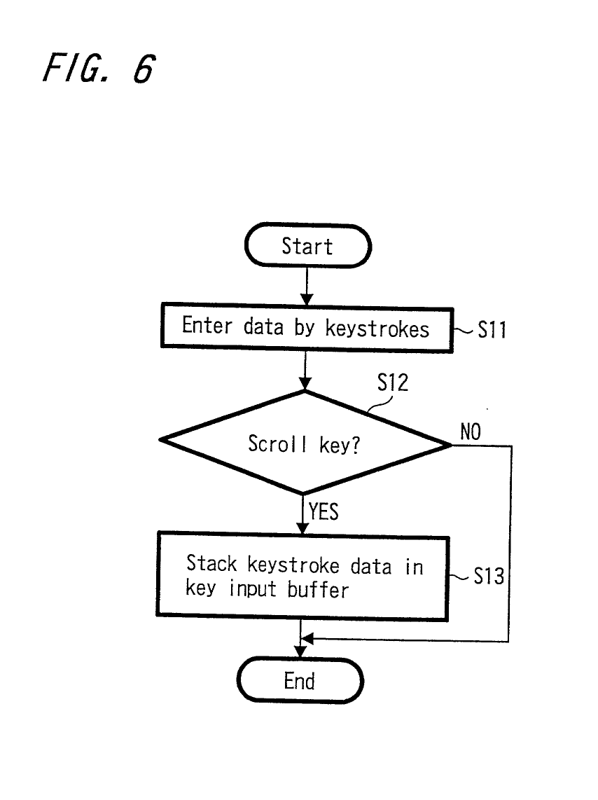

FIG. 6 is a flowchart showing a processing of data inputted by user's keystrokes.

Referring to FIG. 6, and following the start of operation, there is executed a key input processing at a step S11. To be concrete, the CPU 6 recognizes that keystroke data are inputted by the keys 4.

It is determined at the next decision step S12 whether or not keystroke data is entered by scroll keys. To be concrete, it is determined at the decision step S12 by the CPU 6 whether or not keystroke data entered by the keys 4 is keystroke data for instructing scrolling.

If keystroke data is keystroke data for instructing scrolling at the decision step S12, control goes to a step S13, whereat inputted keystroke data is accumulated in the key input buffer 5.

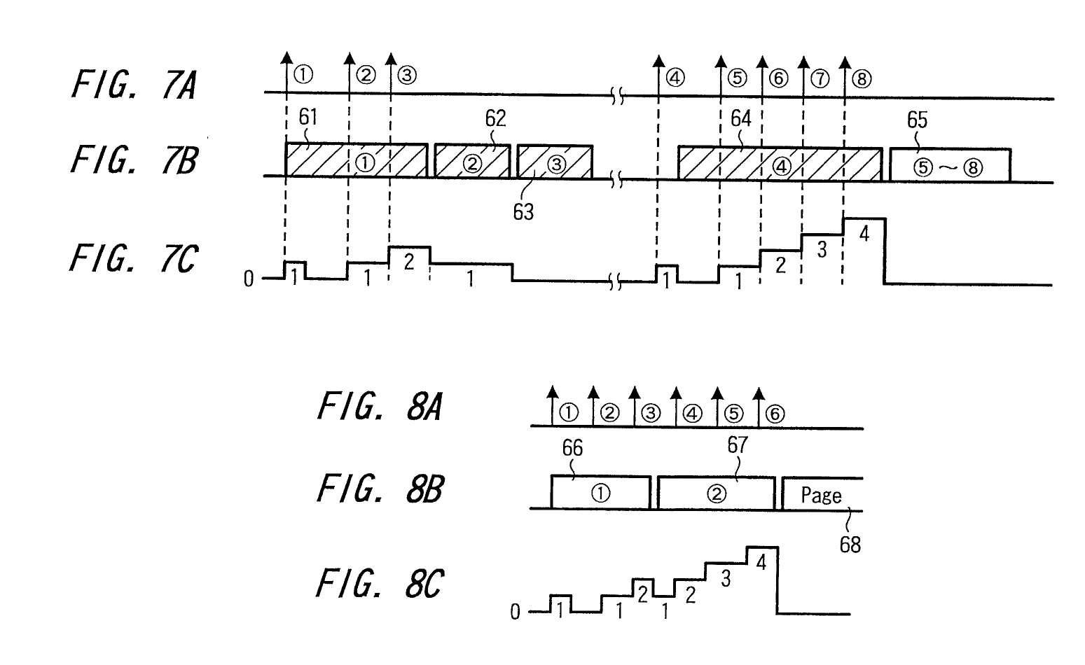

FIGS. 7A, 7B, 7C are respectively diagrams showing a processing for keystroke and the number of inputted keystroke data stored in the key buffer 5, wherein FIG. 7A shows keystroke data entered by the keys 4, FIG. 7B shows a display processing executed on the LCD 9 by the CPU 6 and FIG. 7C shows the number of processing which is not yet effected on the key buffer 5.

In the sheets of drawings, numerals having open circles of keystroke data and processing correspond to numerals of “ ” of keystroke data and processing in the specification and indicate the number of keystroke data. Further, in the sheets of drawings, numerals indicating the number of keystroke data stored in the key buffer correspond to numerals of “ ” of the number of keystroke data in the key buffer in the specification and indicate the number of data in the key buffer 5. Also, in FIGS. 8A to 8C, FIGS. 9A to 9C, FIGS. 10A to 10C and FIGS. 11A to 11C, numerals having open circles of keystroke data and processing correspond to numerals of “ ” of keystroke data and processing in the specification and indicate the number of keystroke data similarly.

When keystroke data “1”, “2”, “3” are entered as shown in FIG. 7A, in the number of keystroke data stored in the key buffer 5 shown in FIG. 7C, “1” is entered for the keystroke inputted data “1” shown in FIG. 7A, “1” is entered for the keystroke inputted data “2” and “2” is entered for the keystroke inputted data “3”. At that time, in the processing shown in FIG. 7B, there are executed one line scroll 61 based upon the processing “1” for the key buffer input number “1”, one line scroll 62 based upon the processing “2” for the key buffer input number “2” and one line scroll 63 based upon the processing “3” for the key buffer input number “1” shown in FIG. 7C.

Subsequently, when keystroke data “4”, “5”, “6”, “7”, “8” are entered as shown in FIG. 7A, the number of key buffer input data shown in FIG. 7C is presented such that “1” is entered for the keystroke input “4” shown in FIG. 7A, “1” is entered for the keystroke input “5”, “2” is entered for the keystroke input “6”, “3” is entered for the keystroke input “7” and “4” is entered for the keystroke input “8”. At that time, in the processing shown in FIG. 7B, there are executed one line scroll 64 based upon the processing “4” for the key buffer input number “1” and page scroll 65 based upon the processings “5”, “6”, “7”, “8” for the key buffer input number “4”.

FIGS. 8A, 8B and 8C are diagrams showing processings executed for keystroke inputted data indicating scrolling to different directions, i.e., other keystroke inputted data and the key buffer input number.

When keystroke data “1”, “2”, “3”, “4”, “5”, “6” are entered as shown in FIG. 8A, in the key buffer input number shown in FIG. 8C, “1” is entered for the keystroke inputted data “1” shown in FIG. 8A, “1” is entered for the keystroke inputted data “2”, “2” is entered for the keystroke inputted data “3”, “2” is entered for the keystroke inputted data “4”, “3” is entered for the keystroke inputted data “5” and “4” is entered for the keystroke inputted data “6”. At that time, in the processing shown in FIG. 8B, there are executed one line scroll 66 based upon the processing “1” for the key buffer input number “1”, one line scroll 67 based upon the processing “2” for the key buffer input number “2” and page scroll 68 based upon the processings “3” to “6” for the key buffer input number “4”.

While the operations of the present invention have been described so far on the assumption that lines and pages should be fed in the same direction, let us describe operations of the present invention on the assumption that the feeding directions are different, including the upward direction ↑ and the downward direction ↓.

FIGS. 9A, 9B and 9C are respectively diagrams showing a page feed processing as a pattern 1.

When keystroke data “1”, “2”, “3”, “4” of the upward direction ↑ are entered as shown in FIG. 9A and keystroke data “5” of the downward direction ↓ is entered, in the key buffer input number shown in FIG. 9C, “1” of the upward direction is entered for the keystroke inputted data “1” shown in FIG. 9A, “1” of the upward direction is entered for the keystroke inputted data “2”, and “2” of the upward direction is entered for the keystroke inputted data “3”, “3” of the upward direction is entered for the keystroke inputted data “4” and “3” of the upward direction and “1” of the downward direction and remaining “1” of the downward direction are entered for the keystroke inputted data “5”.

At that time, in the processing shown in FIG. 9B, there are executed one line scroll 71 of the upward direction based upon the processing “1” for the upward direction key buffer input number “1”, page scroll processing 72 of the upward direction based upon the processings “2” to “4” for the upward direction key buffer input number “3” and one line scroll 73 of the downward direction based upon the processing “5” for the remaining downward direction key buffer input number “1”.

A buffer evaluation time for the one line feed scroll 71 of the upward direction is T1, a buffer evaluation time of the page feed scroll processing 72 of the upward direction is T2, and a buffer evaluation time for the one line feed scroll processing 73 of the downward direction is T3.

As described above, when the evaluation time of the key buffer input number is set to a time at which decoding of data read out from the dictionary is started, a plurality of inputted keystroke data are arranged as other processing, whereby a user can scroll the screen to feed pages in the upward direction and to feed one line in the downward direction.

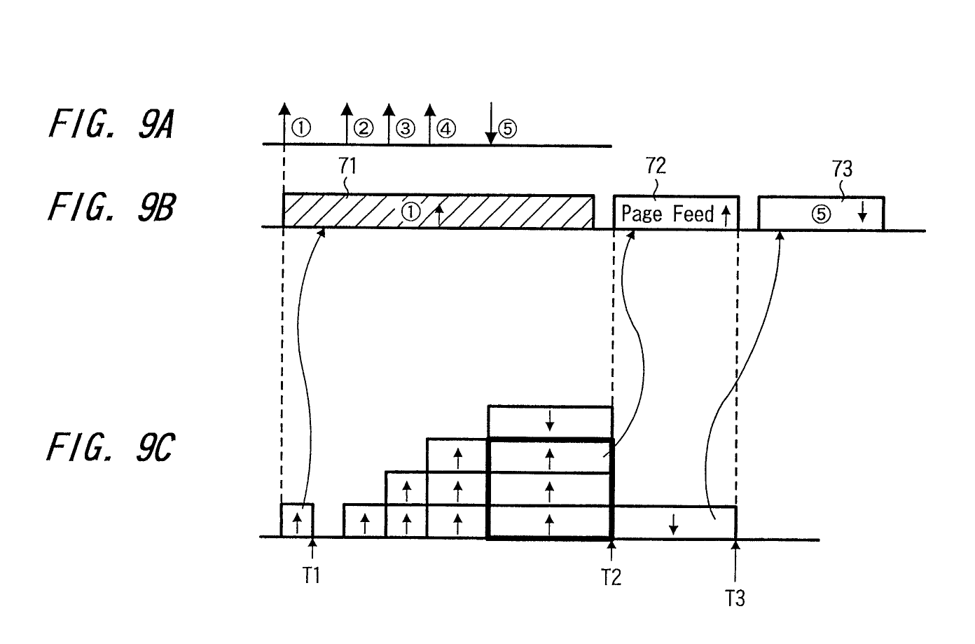

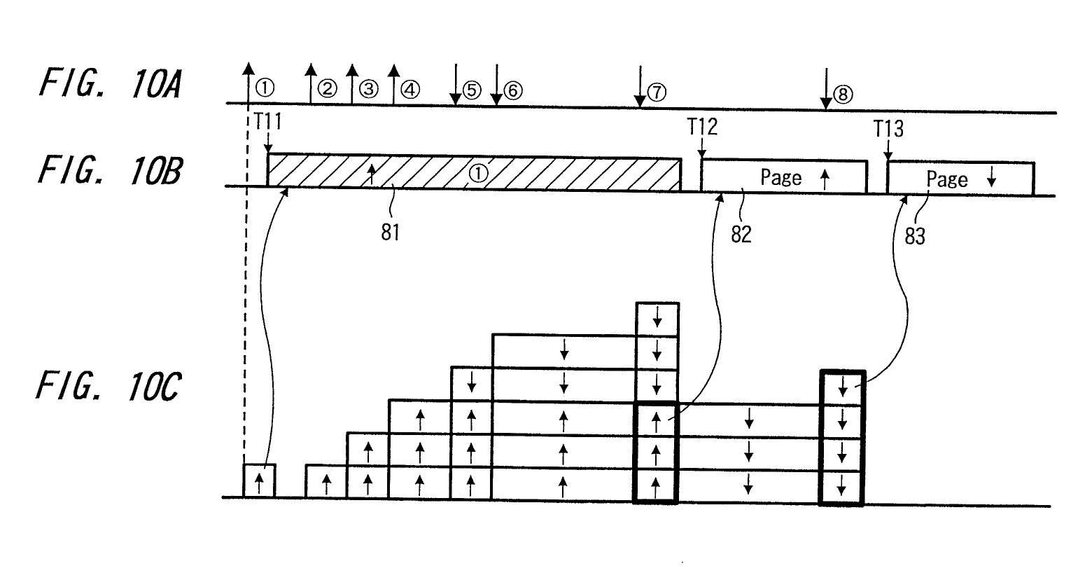

FIGS. 10A, 10B and 10C are respectively diagrams showing a scroll processing as a pattern 2.

When keystroke data “1”, “2”, “3”, “4” of the upward direction tare entered and keystroke data “5”, “6”, “7”, “8” of the downward direction ↓ are entered as shown in FIG. 10A, in the key buffer input number shown in FIG. 10C, “1” of upward direction is entered for the keystroke inputted data “1” shown in FIG. 10A, “1” of upward direction is entered for the keystroke inputted data “2”, “2” of upward direction is entered for the keystroke inputted data “3”, “3” of upward direction is entered for the keystroke inputted data “4”, “3” of upward direction and “1” of downward direction are entered for the keystroke inputted data “5”, “3” of upward direction and “2” of downward direction are entered for the keystroke inputted data “6”, “3” of upward direction and “3” of downward direction are entered for the keystroke inputted data “7” and remaining “4” of downward direction is entered for the keystroke inputted data “8”.

At that time, in the processing shown in FIG. 10B, there are executed one line scroll 81 of upward direction based upon the processing “1” for the upward direction key buffer input number “1”, page scroll processing 82 of upward direction based upon the processings “2” to “4” for the upward direction key buffer input number “3” and page scroll 83 of downward direction based upon the processings “5” to “8” for the remaining downward direction key buffer input number “4”.

A time required for the upward direction one line scroll 81 is determined in consideration of a time of a decompression processing which are a display processing and an expanding processing. A buffer evaluation time for the one line feed scroll 81 of the upward direction is T11, a buffer evaluation time for the page feed scroll processing 82 of the upward direction is T12 and a buffer evaluation time for the page feed scroll processing 83 of the downward direction is T13.

As described above, when the key buffer input number is evaluated at a time at which the preceding processing is ended, a user can scroll the screen to feed pages in the upward direction and in the downward direction by three continuous line feed commands of the upward direction and the downward direction.

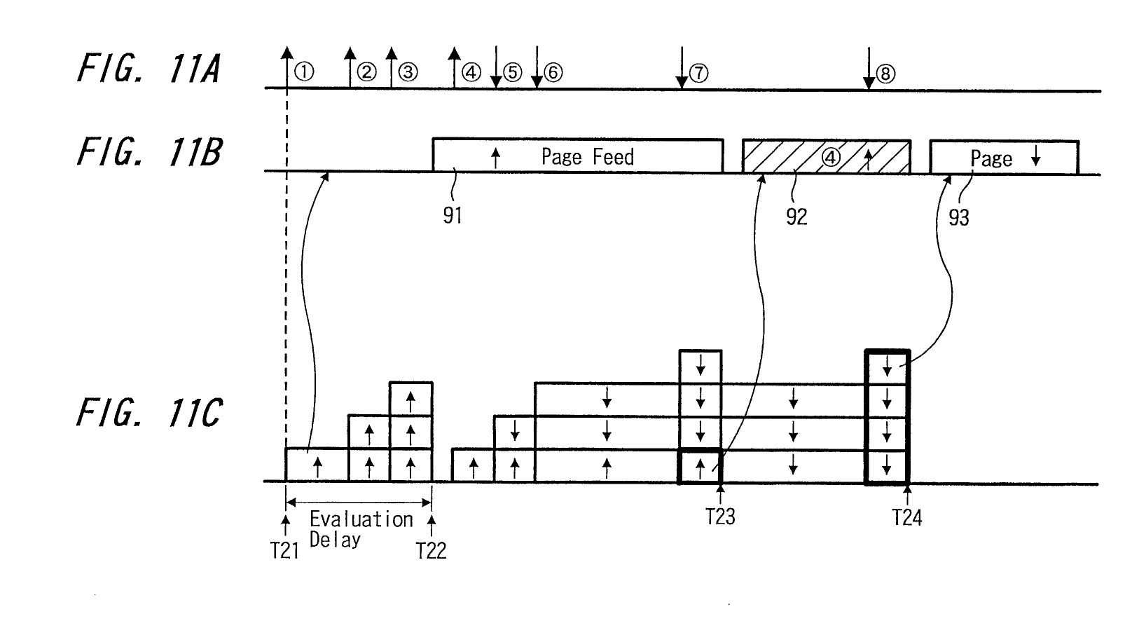

FIGS. 11A, 11B and 11C are respectively diagrams showing a scroll processing as a pattern 3. When keystroke data “1”, “2”, “3”, “4” of upward direction ↑ and keystroke data “5”, “6”, “7”, “8” of downward direction ↓ are entered as shown in FIG. 11A, in the key buffer input number shown in FIG. 11C, “1” of upward direction is entered for the keystroke inputted data “1” shown in FIG. 11A, “2” of upward direction is entered for the keystroke inputted data “2”, “3” of upward direction is entered for the keystroke inputted data “3”, remaining “1” of upward direction is entered for the keystroke inputted data “4”, “1” of upward direction and “1” of downward direction are entered for the keystroke inputted data “5”, “1” of upward direction and “2” of downward direction are entered for the keystroke inputted data “6”, “1” of upward direction and “3” of downward direction are entered for the keystroke inputted data “7” and remaining “4” of downward direction is entered for the keystroke inputted data “8”.

At that time, in the processing shown in FIG. 11B, considering the evaluation delay from T21 to T22, there are executed a page feed scroll 91 of upward direction based upon the upward direction keystroke input data “1”, “2”, “3” as the processing for the upward direction key buffer input number “3”, a line feed scroll processing 92 of upward direction based upon the upward direction keystroke input data “4” as the processing for the upward key buffer input number “1” and a page feed scroll 93 of downward direction based upon the downward direction keystroke input data “5” to “8” as the processing for the remaining downward direction key buffer input number “8”.

A time required by the page feed scroll 91 of the upward direction is determined in consideration of a time required by a decompression processing which are a display processing and an expanding processing, for example. A buffer evaluation time for the upward direction page feed scroll 91 is T22, a buffer evaluation time for the upward direction line feed scroll processing 92 is T23, and a buffer evaluation time for the downward direction page feed scroll processing 93 is T24. T21 to T22 is time which is determined in consideration of the evaluation delays.

As described above, when the key buffer input number is evaluated after a predetermined time had elapsed, if a number of keystroke data are entered in a short period of time, then a user can scroll a display image to feed pages without a rest so as to decrease a scroll key input dead time caused by a delay of one line scroll processing time.

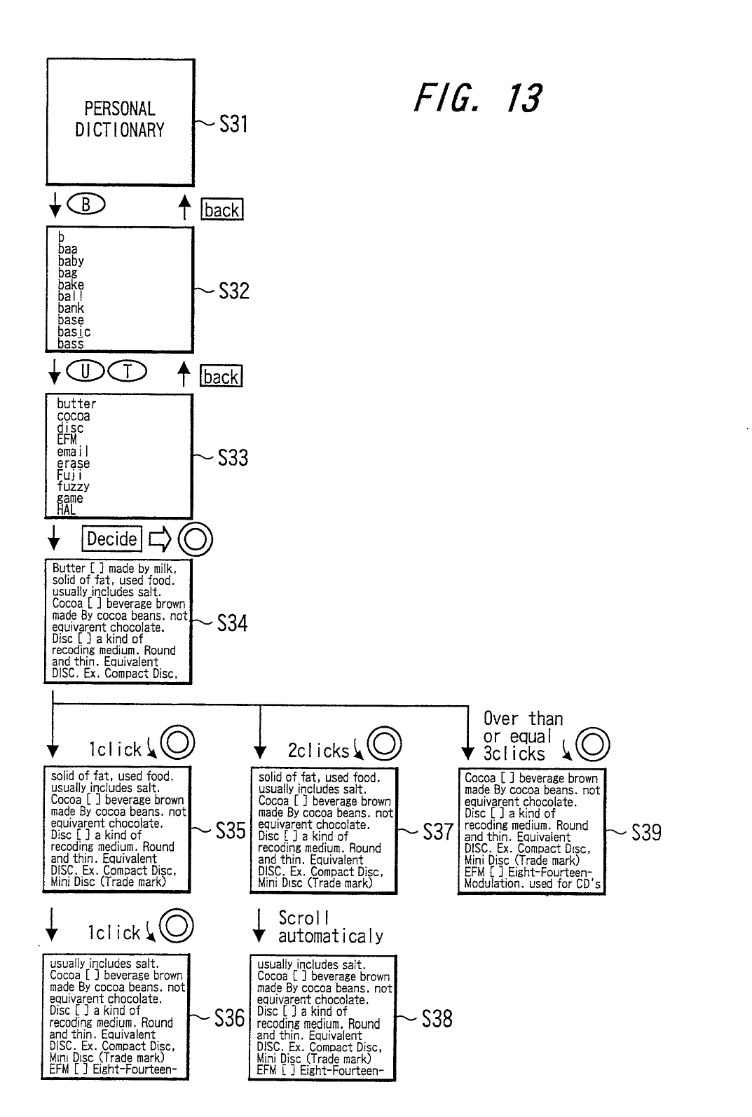

FIG. 13 is a diagram showing a dictionary fundamental operation flow which is used to retrieve meanings of English words. FIG. 13 shows a forward matching retrieval in which characters lying in front of words are sequentially retrieved.

Referring to FIG. 13, a retrieval start display image of a dictionary is opened at a step S31. When “B” is entered by user's keystrokes at the step S31, an entry of “b” is displayed as shown at a step S32. To be concrete, when “B” is entered by user's keystrokes of the keys 4, the entry of “b” is displayed on the LCD 9. When “U” and “T” are entered by user's keystrokes at the step S32, an entry of “butter” is displayed as shown at a step S33. To be concrete, when “U” and “T” are entered by user's keystrokes of the keys 4, the entry of “butter” is displayed on the LCD 9. If the entry is decided at the step S33, then contents of the entry of “butter” are displayed as shown at a step S34. To be concrete, when the user presses the jog dial 101 in the radius direction, all of three lines of the entry of “butter” are displayed on the LCD 9. Subsequently, three lines of an entry of “cocoa” is displayed on the LCD 9. Further, four lines of an entry of “disc” are displayed on the LCD 9.

At the step S34, when the user rotates the jog dial 101 in the “↓” direction one click in such a manner that the page is scrolled in the forward direction, one line is scrolled and displayed at a step S35. To be concrete, when the user rotates the jog dial 101 one click in the positive direction forward, one line is scrolled and fed so that three lines of the entry of “butter” are displayed on the LCD 9. Subsequently, three lines of the entry of “cocoa” are displayed on the LCD 9. Further, five lines of the entry of “Disc” are displayed on the LCD 9.

At the step S35, when the user rotates the jog dial 101 in the “↓” direction one click in such a manner that the page is scrolled in the forward direction, one line is scrolled and fed and thereby displayed at a step S36. To be concrete, when the user further rotates the jog dial 101 one click in the positive direction forward, one line is scrolled and fed so that two lines of the entry of “butter” are displayed on the LCD 9. Subsequently, three lines of the entry of “cocoa” are displayed on the LCD 9. Further, six lines of the entry of “Disc” are displayed on the LCD 9.

At the step S34, when the user rotates the jog dial 101 in the “↓” direction two clicks in such a manner that the page is scrolled in the forward direction, one line is scrolled, fed and displayed at a step S37. To be concrete, when the user rotates the jog dial 101 in the forward direction two clicks, one line is fed by scrolling and thereby three lines of the entry of “butter” are displayed on the LCD 9 and three lines of the entry of “cocoa” are displayed on the LCD 9. Further, five lines of the. entry of “Disc” are displayed on the LCD 9.

Then, at a step S38, one line is fed by scrolling and displayed on the LCD 9. To be concrete, after the step S37, one line is fed by scrolling and two lines of the entry of “butter” are displayed on the LCD 9. Subsequently, three lines of the entry of “cocoa” are displayed on the LCD 9. Further, six lines of the entry of “Disc” are displayed on the LCD 9. Display at the step S38 is automatically scrolled and executed after a predetermined time period since the display at the step S37 was completed. The processing at the step S38 may be executed immediately after the processing at the step S37 was finished. When control goes from the step S35 to the step S36, after one line was scrolled from the state of the step S34, the user operates the jog dial 101 to instruct the scrolling, thereby resulting in the step S35 being executed. Further, after one line was scrolled from the state of the step S35, when the user operates the jog dial 101 to instruct the scrolling, the step S36 is executed. On the other hand, when the steps S37 and S38 are executed, the user clicks the scroll instruction jog dial 101 twice so that the step S36 is automatically executed after the step S35. Specifically, when the steps S35 and S36 are executed, there is assumed such a state in which the user instructs the scrolling while visually confirming the scrolled picture. When the steps S37 and S38 are executed, there is assumed such a state in which the user is sequentially entering scroll instruction while the scrolling at the step S37 is being executed.

At the step S34, when the user clicks the jog dial 101 in the forward three or more times, the page is fed and scrolled at a step S39. To be concrete, when the user clicks the jog dial 101 in the positive direction forward three clicks or more, the page is fed and scrolled so that three lines of the next entry of “cocoa” are displayed on the LCD 9. Subsequently, entries of “Disc” and “EFM” are displayed on the LCD 9. In the case of the step S39, unlike the case of the steps S37 and S38, the displayed picture is scrolled at the unit of pages in order to restrain the sense of incongruity from being caused to the user by the delay of processing when the jog dial 101 is operated three clicks or more.

In the above dictionary fundamental operation flow, there is shown the forward scrolling retrieval. The present invention is not limited to the forward scrolling retrieval and the processing is similarly executed in the operation for returning the pages. Since data is expanded and opened from the text of the first line of the heading of the entry and displayed in the first display at the step S34, when return of a line, for example, is instructed, the previous line is opened and displayed. A unit at which minimum data is expanded and opened is determined by a degree of compression. When data is compressed, since a display size is not taken into consideration, data may be opened by about one line amount or at the unit of pages or more.

While compressed data is expanded and displayed in the above embodiment, the present invention is not limited thereto and can also be applied to data which is not compressed. In this case, an expanding processing time for compressed data may not be considered but only a display processing may be considered.

While a page is fed and scrolled by three clicks or more in the above embodiment, the present invention is not limited thereto and the number of clicks may be properly changed to 4 clicks or more, 5 clicks or more and so on in accordance with an expanding processing time for compressed data.

According to the above embodiment, in the electronic dictionary, the line feed and the page feed can be distinguished from each other and data can be scrolled and displayed based upon a predetermined number of clicks and speeds of clicks of the so-called jog dial which can feed and return lines when it is rotated in the positive direction or in the opposite direction and which can enter decision when it is pressed in the radius direction.

According to the above embodiment, in the electronic dictionary, since the jog dial can easily be rotated in the positive direction or in the opposite direction, two lines can be fed and scrolled or pages can be fed and scrolled by two clicks or three clicks with ease.

In the electronic dictionary, when several lines of dictionary data of the area of the non-expanding processing are continuously scrolled and displayed in order to display dictionary data compressed and recorded on the dictionary memory after it had been expanded, since a time for expanding the compressed dictionary data is required, a scroll operation is momentarily delayed so that a user inevitably feels a sense of incongruity relative to scroll and display.

While the user can enter many clicks by the jog dial 101, if dictionary data is displayed on the LCD 9 as it is based upon the number of inputted clicks, then so long as dictionary data is being read out from the SRAM 3, lines are fed and pages are fed so that dictionary data can be readily displayed on the LCD 9. However, when dictionary data to be displayed are all read out from the SRAM 3, dictionary data should be expanded. If input command data of line feed which is not yet processed still remains in the key buffer 5, then an irregular display operation will not be avoided such that lines of dictionary data read out are fed in accordance with the remaining line feed input command data.

According to the above embodiment, in order to prevent the above disadvantage, two continuous line feed input command data stored in the key buffer 5 while data is being displayed on the LCD 9 may be processed as a line feed command. Three continuous line feed input command data or more may be judged as three continuous line feed input command data and thereby processed as the page feed command. As a result, a sense of incongruity caused when lines are fed can be removed and lines can be fed smoothly and pages can be fed smoothly. Thus, a quality of display can be improved.

According to the above embodiment, when the user scrolls a display image to feed pages, the display area on the LCD 9 is comprised of 8 lines, if the entry of display data on the LCD 9 falls within 8 lines, then the next entry is scrolled. If the above entry is comprised of 8 lines or more, then the user may scroll the display image to feed 8 lines.

While the electronic dictionary has been described so far by way of example in the above embodiment, the present invention is not limited thereto and can be applied to an electronic device such as an electronic note and a cellular phone in which data recorded on a recording medium is read out, scrolled and displayed on a display means so long as the electronic device has a similar arrangement and achieves a similar action.

According to the present invention, there is provided a reproducing apparatus for reading out compressed display data comprising a plurality of coupled page data from a recording medium and displaying the display data based upon operations by a user. This reproducing apparatus is comprised of a reproducing device for reproducing and reading out the compressed display data from the recording medium as reproducing data, a data restoring device for expanding the compressed reproducing data to restore original display data, a memory for storing therein the display data restored by the data restoring device, a display device for displaying a predetermined portion of the display data stored in the memory as display data, an operation device for entering instruction information to instruct the direction in which display data displayed on the display device is scrolled, a hold device for holding instruction information entered by the operation device each time the operation device is operated and a control device for scrolling display data displayed on the display device at the unit of page data when instruction information held on the hold device instructs scroll in which display data is continuously scrolled in the same direction over a predetermined number of times.

Further, according to the present invention, there is provided a reproducing apparatus for reading out display data comprising a plurality of coupled page data from a recording medium and displaying the display data on a display screen based upon operations by a user. This reproducing apparatus is comprised of a reproducing device for reproducing and reading out the display data from the recording medium as reproducing data, a display data processing device for processing the reproduced reproducing data such that the reproduced reproducing data matches the display screen and outputting the processed reproducing data as display data, a control device for displaying part of the display data on the display screen as display data, an operation device for entering instruction information to instruct the direction in which the control device scrolls displayed pictures and an instruction information hold device for holding instruction information entered by the operation device, wherein the control device scrolls display data displayed on the display screen at the unit of page data when instruction information held on the hold device instructs scroll in which display data is continuously scrolled in the same direction over a predetermined number of times. As a result, a sense of incongruity caused when lines are fed can be removed, lines can be fed smoothly and pages can be fed smoothly. There is achieved an effect that the quality of playback and display can be improved.

According to the reproducing apparatus of the present invention, in the above, since data displayed on the display device is character data of the predetermined size, a plurality of lines, each of which is comprised of less than characters of a predetermined number, are accumulated and displayed and the amount scrolled by a single scroll command is the line unit, a user can scroll a display image to feed lines by the single scroll command.

According to the reproducing apparatus of the present invention, in the above, since the scroll amount required when the continuous scroll instructions of the same direction are over the predetermined number and stored in the memory is the page scroll in which data displayed on the display device is scrolled and new data is displayed, if continuous scroll instructions of the same direction are over the predetermined number, then a user can scroll a display image to feed pages.

Further, according to the reproducing apparatus of the present invention, in the above, since the page scrolling is such one in which the next entry is scrolled when the lines of character data comprising each entry are less than lines of a predetermined number and in which a predetermined line of the same entry is scrolled when lines of character data are less than lines of a predetermined number, if an entry is a relatively short entry in which all data are displayed within the display area of the display device, then the next entry is scrolled. If an entry is a relatively long entry in which all data are not displayed within the display area of the display device, there is then achieved the effect that the next line which is not yet displayed on the display area can be displayed.

Furthermore, according to the present invention, there is provided a reproducing method of reading out display data from a recording medium in which the display data comprising a plurality of coupled page data are stored and displaying a picture on a display screen based upon user's operations held in a hold device in which user's instruction is held each time a user operates a reproducing apparatus. This reproducing method is comprised of the steps of a step of reproducing and reading out the display data from the recording medium, a step of converting the read out display data into data of a data format that can be displayed on a display screen, a step of displaying the converted display data of data format, which can be displayed on the display screen, on the display screen, a step of converting continuous instructions over a predetermined number from the same user into other operation instructions when user's instructions held in the hold device are same continuous instructions over a predetermined number and a step of displaying display data based upon the other instructions when user's instructions are converted into the other instructions. Therefore, since several line feed scroll commands can be changed to the page feed command and then processed, a sense of incongruity caused when lines are fed can be removed, lines can be fed smoothly and pages can be fed smoothly. There is achieved an effect that the quality of playback and display can be improved.

Having described a preferred embodiment of the invention with reference to the accompanying drawings, it is to be understood that the invention is not limited to that precise embodiment and that various changes and modifications could be effected therein by one skilled in the art without departing from the spirit or scope of the invention as defined in the appended claims.

What is claimed is:

1. A reproducing apparatus for reading out compressed display data comprising a plurality of coupled page data from a recording medium and displaying said display data based upon operations by a user, comprising:
reproducing means for reproducing and reading out said compressed display data from said recording medium as reproducing data;
data restoring means for expanding said compressed reproducing data to restore original display data;
memory means for storing therein said display data restored by said data restoring means;
display means for displaying a predetermined portion of said display data stored in said memory means as display data;
operation means for entering instruction information to instruct the direction in which display data displayed on said display means is scrolled;
hold means for holding instruction information entered by said operation means each time said operation means is operated; and
control means for scrolling display data displayed on said display means at the unit of page data when instruction information held on said hold means instructs scroll in which display data is continuously scrolled in the same direction over a predetermined number of times.

2. A reproducing apparatus according to claim 1, wherein said display data is character information of a predetermined display size, said display means displays thereon said display data in such a manner that a plurality of lines are stacked and said control means scrolls said display data at the unit of line when instruction information held on said hold means instructs scroll in which display data is continuously scrolled in the same direction less than a predetermined number of times.

3. A reproducing apparatus according to claim 1, further comprising timer means and wherein said control means judges instruction information held on said hold means after said timer means had counted a predetermined time period.

4. A reproducing apparatus according to claim 3, wherein said timer means counts a time period before said control means judges instruction information if instruction information is entered by said operation means when said data restoring means is not restoring said compressed reproducing data.

5. A reproducing apparatus according to claim 3, wherein said timer means counts a time period before said control means judges instruction information if information is entered by said operation means when instruction information is not held on said hold means.

6. A reproducing apparatus for reading out display data comprising a plurality of coupled page data from a recording medium and displaying said display data on a display screen based upon operations by a user, comprising:
reproducing means for reproducing and reading out said display data from said recording medium as reproducing data;
display data processing means for processing said reproduced reproducing data such that said reproduced reproducing data matches said display screen and outputting said processed reproducing data as display data;
control means for displaying part of said display data on said display screen as display data;
operation means for entering instruction information to instruct the direction in which said control means scrolls displayed pictures; and
instruction information hold means for holding instruction information entered by said operation means, wherein
said control means scrolls display data displayed on said display screen at the unit of page data when instruction information held on said instruction information hold means instructs scroll in which display data is continuously scrolled in the same direction over a predetermined number of times.

7. A reproducing apparatus according to claim 6, further comprising memory means for storing therein said display data processed by said display data processing means and wherein said control means reads out display data of a predetermined size from display data stored in said memory means and displays the display data thus read out on said display screen.

8. A reproducing apparatus according to claim 6, wherein said display data stored in said recording medium is compressed and said display data processing means expands said compressed display data to restore original display data.

9. A reproducing apparatus according to claim 6, wherein said control means scrolls at the unit of page based upon a plurality of instruction information held in said instruction information hold means when instruction information is entered while said display data processing means is processing the reproduced reproducing data.

10. A reproducing apparatus according to claim 6, wherein said reproducing means further includes display means for displaying part of said display data processed by said display data processing means.

11. A reproducing apparatus according to claim 6, wherein said control means erases instruction information held in said instruction information hold means from said instruction information hold means based upon contents of said scroll.

12. A reproducing method of reading out display data from a recording medium in which said display data comprising a plurality of coupled page data are stored and displaying a picture on a display screen based upon user's operations held in a hold means in which user's instruction is held each time a user operates a reproducing apparatus, comprising the steps of:
a step of reproducing and reading out said display data from said recording medium;
a step of converting said read out display data into data of a data format that can be displayed on a display screen;
a step of displaying said converted display data of data format, which can be displayed on said display screen, on said display screen;
a step of converting continuous instructions over a predetermined number from the same user into other operation instructions when user's instructions held in said hold means are same continuous instructions over a predetermined number; and
a step of displaying display data on said display screen based upon said other instructions when user's instructions are converted into said other instructions.

13. A reproducing method according to claim 12, wherein said display data is character data of a predetermined size and is thereby displayed with a predetermined number of lines and a predetermined number of columns on said display screen.

14. A reproducing method according to claim 12, wherein said other processing is scrolling of said page unit when continuous user's instructions of a predetermined number held in said hold means are instructions of scrolling at unit of one line.

15. A reproducing method according to claim 12, wherein said display data stored in said recording medium is compressed with a predetermined format and processing for converting display data into data of data format that can be displayed on said display screen is a processing for expanding said compressed data to restore original display data.

16. A reproducing method according to claim 12, wherein instructions from a plurality of users held in said hold means are converted into other operation instructions while said display data is being converted into data of data format that can be displayed on said display screen.

17. A reproducing method according to claim 12, further comprising a step of erasing said converted user's instructions held in said hold means from said hold means when a plurality of instructions from the same user are converted into other operation instructions.

18. A reproducing method according to claim 12, further comprising a step of storing display data in which said read out display data is converted into data of data format that can be displayed on said display screen in memory means and wherein display data displayed on said display screen is read out from said memory means and displayed on said display screen.

19. A reproducing method according to claim 18, wherein said memory means has a storage capacity larger than an amount of display data displayed on said display screen.

20. A reproducing method according to claim 19, wherein new display data displayed by display scrolling is read out from said memory means and displayed on said display screen when said new display data is already stored in said memory means.
